(19) United States
(12) Patent Application Publication
(10) Pub. No.: US 2013/0211912 A1
(43) Pub. Date: Aug. 15, 2013

(54) SYSTEM, APPARATUS AND METHOD FOR PROVIDING ADVERTISEMENT BASED ON USER INTEREST INFORMATION

(71) Applicant: Samsung Electronics Co., Ltd., (US)

(72) Inventors: Yun-Woo KIM, Gyeonggi-do (KR); Hyun-Jung Lee, Seoul (KR); Won-Suk Yang, Seoul (KR); Jin-Wan Choi, Gyeonggi-do (KR)

(73) Assignee: Samsung Electronics Co., Ltd., Gyeonggi-do (KR)

(21) Appl. No.: 13/764,002

(22) Filed: Feb. 11, 2013

(30) Foreign Application Priority Data
Feb. 10, 2012 (KR) 10-2012-0013767
Feb. 8, 2013 (KR) 10-2013-0014419

(51) Int. Cl. G06Q 30/02

(52) U.S. Cl. CPC G06Q 30/0255
USPC 705/14.53

(57) ABSTRACT

A system, apparatus and method for providing advertisement based on user interest information includes a user interest information search server for searching for user interest information associated with an advertisement request from a device, from among user interest information generated based on device activity information associated with user's device operations, and an advertising server for providing advertisement information corresponding to the searched user interest information from among stored advertisement information, to the device. Thus, the apparatus provides advertisements with a high user interest level from among numerous advertisements based on the user interest information, thereby maximizing advertising efficiency.

### PRIORITY

This application claims priority under 35 U.S.C. §119(a) to Korean Patent Applications filed in the Korean Intellectual Property Office on Feb. 10, 2012 and assigned Serial No. 10-2012-0013767, and on Feb. 8, 2013 and assigned serial No. 10-2013-0014419, the entire disclosures of each of which are incorporated herein by reference.

### BACKGROUND OF THE INVENTION

1. Field of the Invention

The present invention relates generally to an apparatus and method for providing advertisements in a mobile terminal, and more particularly, to an apparatus and method for providing advertisements based on user interest information.

2. Description of the Related Art

Mobile devices, such as smart phones, are regularly used by many people, and comparable with mass media use such as Television (TV) and newspapers and many efforts have been made to profit by providing advertisements on mobile devices.

A basic example of an existing mobile advertising method for providing advertisements on mobile devices is to produce coupons, mileages, discount services, and the like, through text or images, and unilaterally transfer them to user mobile devices. Another mobile advertising method is to post content-type advertisements on Internet pages with high mobile device traffic, and have users consume the content-based advertisements by accessing the wireless Internet pages on their mobile terminal. Another mobile advertising method is to promote pre-designed mobile advertising sites to users, and then have users visit the sites on their mobile terminal.

Recently, an advertising Software Development Kit (SDK)-based mobile advertising method has been widely used. In the advertising SDK-based mobile advertising method, when developing an application (hereinafter referred to as an “app”) or a web app using the advertising SDK, a web app developer produces and provides an app or web including an advertising feature (or advertising client) by which users may receive advertisements corresponding to category, keyword, and/or metadata associated with the app or web. According to the advertising SDK-based mobile advertising method, a mobile device may receive advertisements corresponding to category, keyword and/or metadata associated with the app as the advertising client included in the app is enabled when it downloads the app and executes it, or the mobile device may receive advertisements corresponding to category, keyword and/or metadata associated with the web as the advertising client included in the web is enabled when web browsing is executed.

However, in the former mobile advertising method that sends mobile coupons or mobile messages to attract user's visits to the stores, in many cases, the mobile coupons or mobile messages may not be relevant to the users because they are sent regardless of user interest information, e.g., the information that the users are usually interested in, so they may often be considered as spam messages. In the latter conventional mobile advertising method that entices users to visit separate mobile advertising sites or wireless Internet pages on their mobile terminal, the users may not recall the advertising sites they are interested in.

In addition, the advertising SDK-based mobile advertising method may disadvantageously provide one-sided advertisements regardless of the interest information of individual mobile device users because it simply provides advertisements corresponding to category, keyword and/or metadata that the web app developer inserted into the advertisements in advance when developing the app or web.

### SUMMARY OF THE INVENTION

Therefore, the present invention has been made to solve the above-stated problems occurring in the prior art, and the present invention provides a user interest information-based advertisement providing apparatus and method capable of providing advertisements corresponding to the interest information of individual mobile device users.

Another aspect of the present invention provides an apparatus and method for providing advertisements based on user interest information generated based on user device activity information in a mobile device.

According to an aspect of the present invention, there is provided a system for providing advertisement based on user interest information which includes a user interest information search server for searching for user interest information associated with an advertisement request from a device, from among user interest information generated based on device activity information associated with user device operations, and an advertising server for providing advertisement information corresponding to the searched user interest information from among stored advertisement information, to the device.

According to another aspect of the present invention, there is provided a method for providing advertisement based on user interest information comprising receiving, from a device, user interest information generated based on device activity information associated with user device operations, and providing advertisement information corresponding to the user interest information from among stored advertisement information, to the device.

According to a further aspect of the present invention, there is provided a device which includes a storage for storing device activity information that includes user profile information associated with user's device operations and advertisement consumption information by the user, a communication unit for transmitting the device activity information to an advertisement providing apparatus, and a controller for collecting and storing the device activity information, and transmitting the collected device activity information.

According to yet another aspect of the present invention, there is provided a method for providing advertisement in a device by storing device activity information that includes user profile information associated with user's device operations and advertisement consumption information by the user, and transmitting the device activity information to an advertisement providing apparatus.

According to still another aspect of the present invention, there is provided a storage media for storing a program thereon, performed in a device, for providing advertisement based on user interest information, which comprises transmitting an advertisement request signal based on predetermined application and web-related category and keyword information as a web application executes, and receiving advertisement information corresponding to user interest information in response to the advertisement request signal, and outputting the received advertisement.

### BRIEF DESCRIPTION OF THE DRAWINGS

The above and other aspects, features and advantages of the present invention will be more apparent from the following description taken in conjunction with the accompanying drawings, in which:

FIG. 1 is a diagram illustrating a system for providing advertisements based on user interest information according to an embodiment of the present invention;

FIG. 2 is a diagram illustrating a process of generating user interest information according to an embodiment of the present invention;

FIG. 3 is a diagram illustrating a process of providing advertisements based on user interest information according to an embodiment of the present invention;

FIG. 4 is a diagram illustrating a structure of a device according to an embodiment of the present invention;

FIG. 5 is a flowchart illustrating an operation of collecting device activity information according to an embodiment of the present invention;

FIGS. 6A and 6B are diagrams illustrating setting screens for determining whether to authorize collection of device activity information according to an embodiment of the present invention;

FIG. 7 is a flowchart illustrating a process of collecting and storing user profile information according to an embodiment of the present invention;

FIG. 8 is a flowchart illustrating a process of collecting and storing advertisement consumption information according to an embodiment of the present invention;

FIG. 9 is a flowchart illustrating an operation of receiving and outputting advertisements by a device according to an embodiment of the present invention;

FIG. 10 is a diagram illustrating a structure of a user interest information generation server according to an embodiment of the present invention;

FIG. 11 is a flowchart illustrating an operation of a user interest information generation server according to an embodiment of the present invention;

FIG. 12 is a diagram illustrating a structure of a user interest information search server according to an embodiment of the present invention;

FIG. 13 is a flowchart illustrating an operation of a user interest information search server according to an embodiment of the present invention; and

FIG. 14 is a flowchart illustrating an operation of an advertising server according to an embodiment of the present invention.

### DETAILED DESCRIPTION OF EMBODIMENTS OF THE PRESENT INVENTION

Various embodiments of the present invention are described in detail with reference to the accompanying drawings. Throughout the drawings, the same drawing reference numerals will be understood to refer to the same elements, features and structures. In addition, descriptions of well-known functions and constructions are omitted for clarity and conciseness.

According to an aspect of the present invention, there is provided an advertisement providing system and method for receiving, from a device, device activity information that includes information about device activities associated with user device operations, generating user interest information based on the device activity information, and providing advertisements having a high user interest level to the device based on the user interest information.

According to an aspect of the present invention, the device activities include various device activities associated with user device operations (e.g., app execution activities, web browsing activities, multimedia content (music and video) playback activities, and search activities) and various activities associated with user advertisement consumption (e.g., advertisement selection activities and advertisement click activities). The device activity information, which is information about these device activities, includes user profile information (e.g., app execution information, web browsing information, multimedia content (music and video) playback information and search information by a user) and user advertisement consumption information (e.g., device advertisement selection or click information by a user).

According to an aspect of the present invention, the device includes a mobile terminal such as a smart phone, a mobile phone, a notebook computer, and a touch pad, and includes any devices that can receive advertisements based on user interest information.

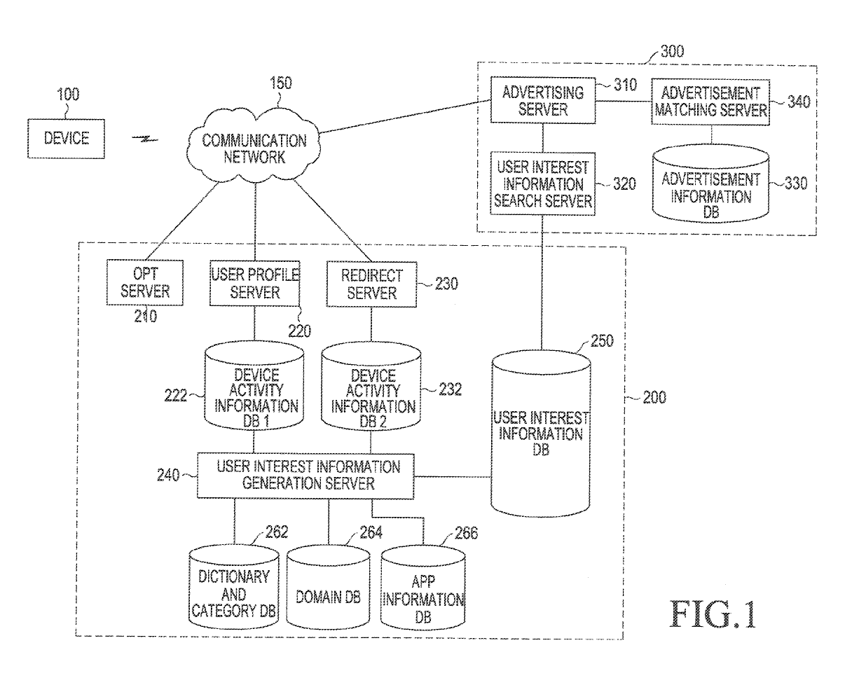

FIG. 1 is a diagram illustrating a system for providing advertisements based on user interest information according to an embodiment of the present invention.

Referring to FIG. 1, a user interest information-based advertisement providing system according to an embodiment of the present invention includes components 200 for generating user interest information based on device activity information associated with user's operations of a device 100, and components 300 for providing advertisements to the device 100 based on the user interest information.

The components 200 for generating user interest information includes an opt server 210, a user profile server 220, a first device activity information database (DB) 222, a redirect server 230, a second device activity information DB 232, a user interest information generation server 240, and a user interest information DB 250.

The opt server 210 stores information indicating whether collection of device activity information associated with user's device operations is authorized for each device, and provides the information to the device 100. Whether collection of device activity information is authorized by the opt server 210 is set by a user of the device 100.

When collection of device activity information is not authorized by the opt server 210, the device 100 does not collect device activity information. However, if collection of device activity information is authorized, the device 100 collects device activity information such as user profile information and advertisement consumption information and transmits the collected device activity information once or a predetermined number of times a day, or upon collection of the device activity information. Specifically, the device 100 collects various user profile information (e.g., app execution information, web browsing information, multimedia content playback information and search information by a user), and transmits the collected user profile information to the user profile server 220. In addition, the device 100 collects user's advertisement consumption information (e.g., advertisement receipt and click information by a user), and transmits the collected advertisement consumption information to the redirect server 230.

The user profile server 220 receives user profile information from the device 100, collects the received user profile information, and stores the collected user profile information in the first device activity information DB 222. The user profile information includes a Device Unique Identification (DUID), app execution information, search information, web browsing information, and multimedia content playback information. The DUID represents a unique ID of the device 100. The app execution information includes executing app information, app execution time, app execution period, app execution location, and app category. The search information includes search keyword, search time, search period, and search location. The web browsing information includes a browsed web site identified by the Uniform Resource Locator (URL). The multimedia content playback information includes music and video playback time, music and video playback period, and music and video category. For example, the user profile server 220 receives user profile information such as “DUID=DUID1, executing app information=Angry Birds®, app execution time=08:00, app execution period=1 hour, app execution location=Gangnam district, app category=game, search keyword=Gangnam restaurant, search time=12:00, search period=30 minutes, search location=Gangnam.” The user profile server 220 collects the user profile information and store the collected user profile information in the first device activity information DB 222.

The redirect server 230 receives user's advertisement consumption information such as advertisement selection or click information by a user, collects the received advertisement consumption information, and stores the collected advertisement consumption information in the second device activity information DB 232.

The device 100 displays advertisements received from an advertising server 310 on an advertising client included in an app or web created using the advertising SDK, and then transmit advertisement display completion information to the redirect server 230. When advertisement is clicked by the user, the device 100 transmits advertisement click information to the redirect server 230. The advertisement display completion 20 information includes a DUID, category information for the displayed advertisement, and keywords for the displayed advertisement. The advertisement click information includes a DUID, category information for the clicked advertisement, and keywords for the clicked advertisement.

The user interest information generation server 240 generates user interest information based on the user profile information and advertisement consumption information (i.e., device activity information) stored in the first and second device activity information DBs 222 and 232, respectively, and stores the generated user interest information in the user interest information DB 250.

Specifically, the user interest information generation server 240 receives device activity information from the first and second device activity information DBs 222 and 232. The user interest information generation server 240 performs operation such as classification, profiling, clustrering, data mining, machine learning to the received device activity information based on dictionary data and category data, which are criteria and stored in a dictionary and category DB 262, domain URL data and URL's category data which are stored in a domain DB 264, and app information data stored in an app information DB 266. For example, the user interest information generation server 240 assigns a category and a keyword(s) to each of device activities including app execution information, search information, multimedia content playback information and advertisement click information, based on dictionary data, category data, URL data, URL's category data and app information data. In addition, the user interest information generation server 240 assigns time data and regional data to each of device activities based on predetermined time and regional segment criteria, and device activity information including app execution information, search information, multimedia content playback information, and advertisement click information. The user interest information generation server 240 calculates a score for each of device activities included in the device activity information based on the weighted criteria (e.g., indicating whether the device activity is the recent activity, and whether a frequency of the device activity is high) representing a predetermined interest level. The user interest information generation server 240 generates user interest information including a DUID, time data, regional data, category, keyword, and score for each of the device activities, and stores the generated user interest information in the user interest information DB 250.

For example, when generating user interest information based on the app execution information, the user interest information generation server 240 may extract an ID of the device that has executed an app, from a DUID of the device that has executed an app indicated by the app execution information, may extract when the app is frequently executed, from the time the app is executed, may extract location information indicating where the app is executed, from the IP address used during app execution, and may extract a category and a keyword of the executed app by determining which app is executed, based on the ID of the executed app. More specifically, the user interest information generation server 240 may extract the information indicating that a user with a DUID of ‘A’ frequently executes a restaurant search app in the vicinity of the location X at about 11 AM on weekdays, and store the extracted information in the user interest information DB 250.

In addition, when generating user interest information by collecting web browsing information, the user interest information generation server 240 may extract a DUID of the device that has performed web browsing, may extract when the web browsing is frequently performed, from the time the web browsing is performed, may extract location information indicating where the web browsing is performed, from the IP address used during web browsing, and may extract a category and a keyword of a URL to which the web browsing is performed, by determining to which URL the web browsing is performed, from the URL to which the web browsing is performed. More specifically, the user interest information generation server 240 may extract the information indicating that a user with a DUID of ‘B’ frequently browses the news web pages in the vicinity of the location Y at about 7 AM in the early morning, and store the extracted information in the user interest information DB 250.

Furthermore, when generating user interest information by collecting search information, the user interest information generation server 240 may extract a DUID of the device that has performed a search, may extract when the search is frequently performed, from the time the search is performed, may extract the location information indicating where the search is performed, from the IP address used during the search, and may extract a category and a keyword by determining which keyword is searched, from the search keyword used for the search.

Moreover, when generating user interest information by collecting multimedia content playback information, the user interest information generation server 240 may extract a DUID of the device that has played the multimedia content, may extract when the multimedia content is frequently played, from the time the multimedia content is played, may extract location information indicating where the multimedia content is played, from the IP address used during playback of the multimedia content, and may extract a category and a keyword by determining which multimedia content is played, based on a ID of the played multimedia content.

The components 300 for providing advertisements to the device 100 based on the generated user interest information includes the advertising server 310, a user interest information search server 320, an advertisement information DB 330, and an advertisement matching server 340.

The advertising server 310 receives an advertisement request signal from the device 100, and analyzes the received advertisement request signal, which includes a DUID, regional information, category and keyword information of the advertisement the device 100 desires to receive, among other information the device 100 requires to receive the advertisement. Upon receiving the advertisement request signal, the advertising server 310 requests user interest information for the user of the device 100 from the user interest information search server 320 based on DUID, regional information, and information about the time the advertisement request was received, all of which are included in the advertisement request signal, and receives the requested user interest information. The advertising server 310 requests, from the advertisement matching server 340, information included in the advertisement request signal from the device 100 and advertisement corresponding to the user interest information. Upon receiving, from the advertisement matching server 340, information included in the advertisement request signal by the device 100 and advertisement information corresponding to the user interest information, the advertising server 310 provides the advertisement information to the device 100.

Upon receiving a user interest information request from the advertising server 310, the user interest information search server 320 searches the user interest information DB 250 for user interest information matching the provided DUID, advertisement request time, and advertisement request region, which are included in the user interest information request signal. The user interest information search server 320 provides the resulting searched (or detected) user interest information to the advertising server 310.

The advertisement information DB 330 stores advertisement information, and the advertisement information includes a category for each advertisement, a keyword(s) for each advertisement, and advertisement data. The advertisement data, advertisement received from at least one advertiser, includes at least one advertisement represented in videos, photos, texts, web site address, etc. The category for each advertisement includes category information for each of advertisements included in the advertisement data. The keyword for each advertisement includes keyword information for each of advertisements included in the advertisement data.

Upon receiving an advertisement information request from the advertising server 310, the advertisement matching server 340 searches the advertisement information DB 330 for advertisement information corresponding to the information included in the advertisement request signal from the device 100 and the user interest information, and provides the searched advertisement information to the advertising server 310.

Accordingly, the above-described user interest information-based advertisement providing system according to an embodiment of the present invention provides advertisements having a high user interest level among numerous advertisements based on the user interest information, thereby maximizing advertising efficiency.

A method for providing advertisements based on user interest information according to an embodiment of the present invention is described below. The user interest information-based advertisement providing method according to an embodiment of the present invention includes a process of generating user interest information, and a process of providing advertisements based on the generated user interest information.

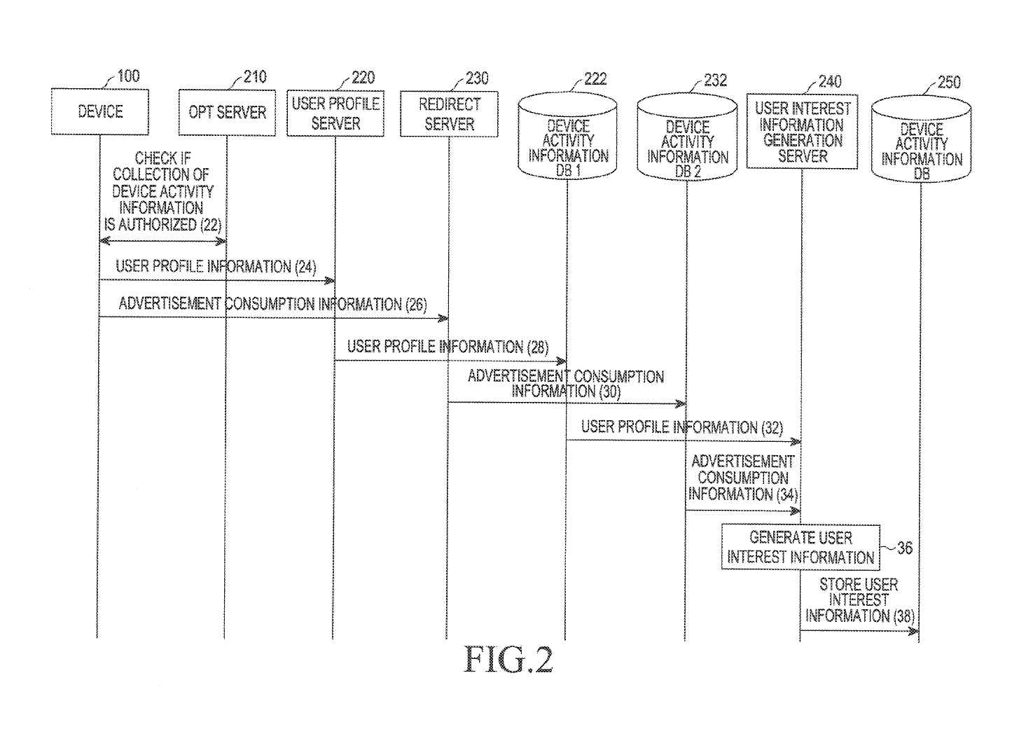

The process of generating user interest information is described below. FIG. 2 is a diagram illustrating a process of generating user interest information according to an embodiment of the present invention.

Referring to FIG. 2, the device 100 determines in Step 22 whether collection of device activity information is authorized, by communicating with the opt server 210. If collection of device activity information is not authorized, the device 100 does not collect device activity information.

However, if collection of device activity information is authorized, the device 100 collects device activity information such as user profile information and advertisement consumption information and transmits the collected device activity information once or a predetermined number of times a day, or upon collection of the device activity information, in Steps 24 and 26. Specifically, in Step 24, the device 100 collects various user profile information associated with user's device operations (e.g., app execution information, web browsing information, multimedia content playback information and search information by a user), and transmits the collected user profile information to the user profile server 220. In Step 26, the device 100 collects user's advertisement consumption information (e.g., advertisement receipt and click information by a user), and transmits the collected advertisement consumption information to the redirect server 230.

In Step 28, the user profile server 220 stores the user profile information received from the device 100 in the first device activity information DB 222. In Step 30, the redirect server 230 stores the advertisement consumption information received from the device 100 in the second device activity information DB 232.

In Steps 32 and 34, the user interest information generation server 240 receives the user profile information and the advertisement consumption information, which are stored in the first and second device activity information DBs 222 and 232, respectively. The user profile information and the advertisement consumption information is referred to herein as “device activity information.”

In Step 36, the user interest information generation server 240 generates user interest information based on the device activity information. Specifically, the user interest information generation server 240 assigns a category and a keyword(s) to each of device activities in the device activity information based on dictionary data and category data which are criteria, and assigns time data and regional data to each of device activities in the device activity information based on predetermined time and regional segment criteria. The user interest information generation server 240 calculates a score for each of device activities included in the device activity information depending on weighted criteria (e.g., indicating whether the device activity is the recent activity, and whether a frequency of the device activity is high) representing a predetermined interest level. The user interest information generation server 240 generates user interest information including a DUID, time data, regional data, category, keyword, and score, for each of the device activities.

In Step 38, the user interest information generation server 240 stores the generated user interest information in the user interest information DB 250.

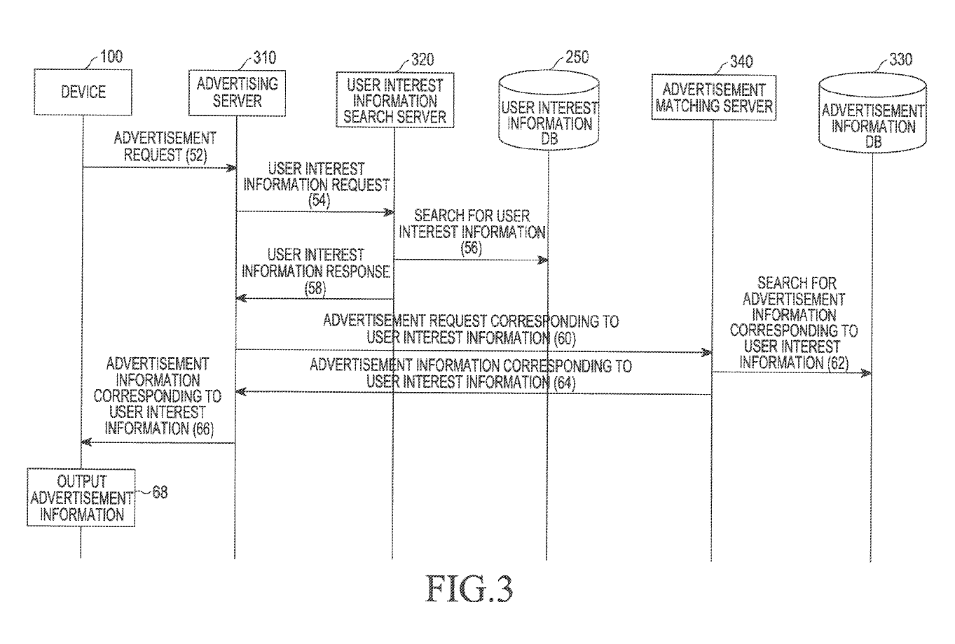

The process of providing advertisements based on the generated user interest information is described below. FIG. 3 is a diagram illustrating a process of providing advertisements based on user interest information according to an embodiment of the present invention.

Referring to FIG. 3, by executing an app or web produced using the advertising SDK, the device 100 enables an advertising client included in the app or web, and the enabled advertising client transmits an advertisement request signal to the advertising server 310 in Step 52. The advertisement request signal includes a DUID, location information, executing app information, predetermined app-related category and keyword information, and other information needed to receive advertisements. In addition, the advertisement request signal includes a DUID, location information, web browsing information (i.e. URLs), predetermined app and web-related category and keyword information, and other information needed to receive advertisements.

Upon receiving the advertisement request signal, the advertising server 310 transmits a user interest information request signal for requesting user interest information for a user of the device 100, to the user interest information search server 320 in Step 54. The user interest information request signal includes a DUID corresponding to a unique ID of the device 100, advertisement request region, and advertisement request time.

Upon receiving the user interest information request signal, the user interest information search server 320 searches the user interest information DB 250 for user interest information matching with the DUID, advertisement request time, and advertisement request region included in the user interest information request signal, in Step 56. In Step 58, the user interest information search server 320 transmits a user interest information response signal including the searched user interest information to the advertising server 310.

Upon receiving the user interest information response signal, the advertising server 310 transmits an advertisement request signal including information included in the advertisement request signal from the device 100 and the user interest information, to the advertisement matching server 340 in Step 60. The advertisement request signal including user interest information includes a DUID, location information, executing app and web information, predetermined app and web-related category and keyword information, and user interest category and keyword information corresponding to the user interest information.

Upon receiving the advertisement request signal including user interest information from the advertising server 310, the advertisement matching server 340 searches for advertisement information corresponding to the user interest information from among numerous advertisement information in the advertisement information DB 330, in Step 62. The advertisement matching server 340 searches for advertisement information corresponding to the user interest information by matching the DUID, location information, executing app and web information, predetermined app and web-related category and keyword information, and user interest category and keyword information included in the advertisement request signal, with the advertisement information stored in the advertisement information DB 330. In Step 64, the advertisement matching server 340 transmits the searched advertisement information corresponding to the user interest information to the advertising server 310.

Upon receiving the advertisement information corresponding to the user interest information, the advertising server 310 transmits the received advertisement information corresponding to the user interest information to the device 100 in Step 66.

In Step 68, the device 100 outputs advertisement(s) based on the advertisement information received from the advertising server 310. The device 100 outputs or displays web sites, videos, images and the like corresponding to the advertisement information, on its display.

In the above-described user interest information-based advertisement providing method according to an embodiment of the present invention, as an app or web browsing executes, the device 100 requests app and web browsing-based advertisement from the advertising server 310 using an advertising client included in the app or web, receives advertisement based on the user interest information from the advertising server 310, and outputs the received advertisement.

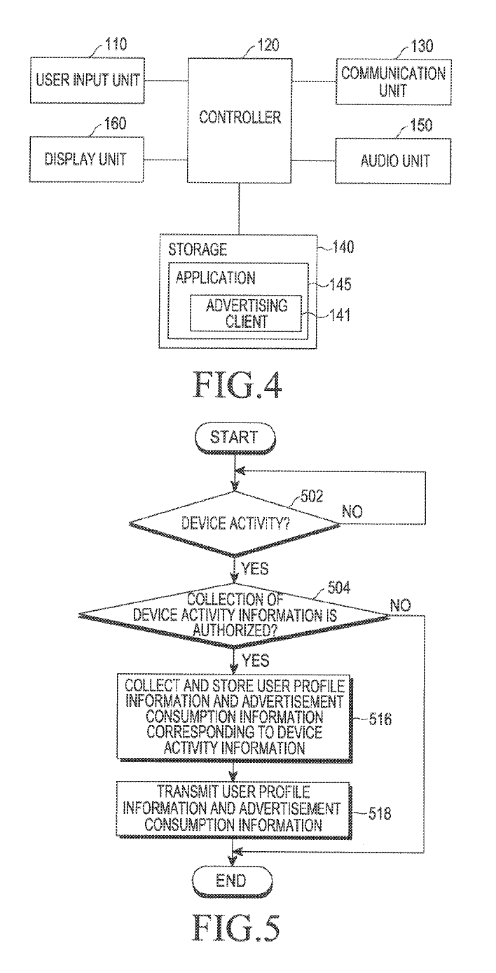

A structure of a device 100 according to an embodiment of the present invention is described in more detail below. FIG. 4 is a diagram illustrating a structure of a device 100 according to an embodiment of the present invention.

Referring to FIG. 4, the device 100 includes a user input unit 110, a controller 120, a communication unit 130, a storage 140, an audio unit 150, and a display 160.

The user input unit 110 includes a keypad, a touch screen or the like having a combination of a plurality of keys for entering various numbers, letters and symbols, and entering various user commands. According to an embodiment of the present invention, the user input unit 110 forwards user inputs such as an advertisement click input by a user, to the controller 120.

The communication unit 130 performs communication under control of the controller 120, and details of the communication and usage thereof may vary depending on the application or function performed in the device 100. According to an embodiment of the present invention, the communication unit 130, under control of the controller 120, transmits user profile information (or information about device activities by a user) and advertisement consumption information (e.g., advertisement selection or click information) to the user profile server 220 and the redirect server 230, respectively. The communication unit 130 receives advertisement information corresponding to user interest information from the advertising server 310.

The storage 140, which includes a nonvolatile memory such as a flash memory and a hard disk, stores data and/or programs needed to operate the device 100. According to an embodiment of the present invention, the storage 140 stores an app 145 including an advertising client 141 produced using the advertising SDK, and stores a web browsing program.

The controller 120 controls the overall operation of the device 100. The controller 120 performs various device activities such as app execution, web browsing, multimedia content playback and search depending on user inputs entered on the user input unit 110. The controller 120 displays advertisements received from the outside, and if the displayed advertisement is clicked by the user, the controller 120 performs an operation associated with the clicked advertisement. Upon request from the user, the controller 120 executes an app or web browsing. If an advertising client included in the app or web is enabled as the app or web browsing, executes, the controller 120 transmits an advertisement request signal by means of the communication unit 130 based on predetermined app and web-related category and keyword information. Upon receiving advertisement information corresponding to user interest information through the communication unit 130, the controller 120 outputs or displays the received advertisement information.

The audio unit 150 outputs various audio signals from the advertising server 310, under control of the controller 120. The display 160 may be implemented as a Liquid Crystal Display (LCD), Organic Light Emitting Diode (OLED), or the like, and under control of the controller 120, the display 160 displays a screen on which operation and/or 30 status of the device 100 is displayed. The display 160 displays advertisement information corresponding to user interest information.

An operation of a device 100 according to an embodiment of the present invention is described in more detail below.

FIG. 5 is a flowchart illustrating an operation of collecting device activity information according to an embodiment of the present invention.

Referring to FIG. 5, the device 100 determines in step 502 whether there is device activity. If there is device activity, the device 100 determines in step 504 whether collection of the device activity information is authorized.

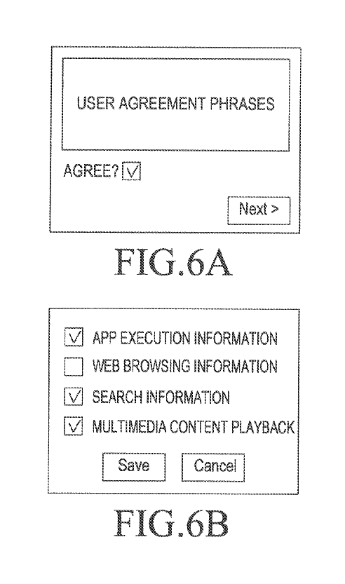

Whether to authorize collection of the device activity information may be set in advance by the user. FIGS. 6A and 6B illustrate setting screens for determining whether to authorize collection of device activity information according to an embodiment of the present invention. Referring to FIGS. 6A and 6B, the device 100 may display an agreement screen on the display 160 as shown in FIG. 6A to gain an agreement about authorization for the collection of device activity information from the user. In addition, the device 100 may display a screen for selecting the device activity information to be collected, on the display 160 as shown in FIG. 6B, allowing the user to determine which device activity information he/she will select from among the app execution information, the web browsing information, the search information, and multimedia content playback information.

If collection of the device activity information is not authorized, the device 100 ends its operation without collecting the device activity information.

However, if collection of the device activity information is not authorized, the device 100 collects and stores user profile information and advertisement consumption information corresponding to the device activity information, in step 516.

More specifically, in a process of collecting and storing user providing information, the device 100 may collect and store, for example, app execution information, web browsing information, search information and multimedia content playback information, as user profile information.

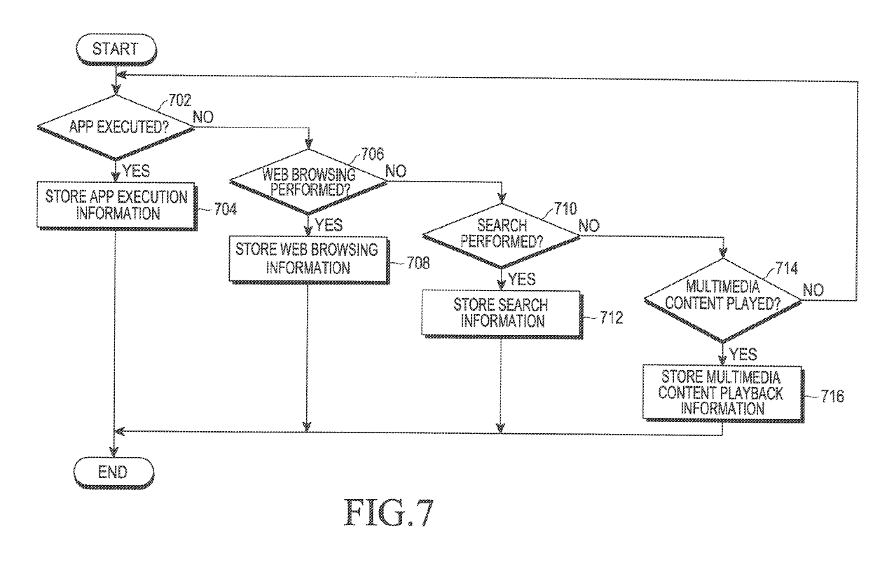

FIG. 7 is a flowchart illustrating a process of collecting and storing user profile information according to an embodiment of the present invention.

Referring to FIG. 7, if an app is executed in step 702, the device 100 stores app execution information in step 704. The app execution information may include the time the app is executed, an IP address used during app execution, and an ID of the executed app. The time the app is executed may have a value in the form of Year/Month/Date/Hour/Minute, for example, 201201022207.

If web browsing is performed in step 706, the device 100 stores web browsing information in step 708. The web browsing information may include the URL access time the web browsing is performed, an IP address used during URL access, and accessed-URL information. The URL access time the web browsing is performed may have a value in the form of Year/Month/Date/Hour/Minute, for example, “201201022207.” The accessed-URL information may be, for example, m.baidu.com.

If a search is performed in step 710, the device 100 stores search information in step 712. The search information may include the time the search is performed, an IP address used during the search, and searched-keyword information. The time the search is performed may have a value in the form of Year/Month/Date/Hour/Minute, for example, “201201022207.”

If multimedia content is played in step 714, the device 100 stores multimedia content playback information in step 716. The multimedia content playback information may include a title of the played content, a playback duration (in seconds), a playback time, an IP address used during playback, and information about played content. The playback time may have a value in the form of Year/Month/Date/Hour/Minute, for example, “201201022207.” If the played content is music, the information about played content may include information about the related people (e.g., singers), the genre and the like, and if the played content is video, the information about played content may include information about the related people (director and lead actor), the genre and the like.

The process of collecting and storing advertisement consumption information will be described in more detail below. The advertisement consumption information may include advertisement selection information and clicked-advertisement information.

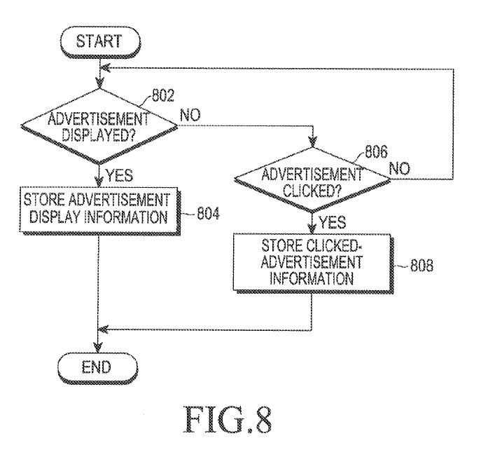

FIG. 8 is a flowchart illustrating a process of collecting and storing advertisement consumption information according to an embodiment of the present invention. Referring to FIG. 8, if an advertisement is displayed in step 802, the device 100 stores advertisement display information in step 804. The advertisement display information may be information indicating the time, place and type of the displayed advertisement. If the advertisement is clicked in step 806, the device 100 stores the clicked-advertisement information in step 808. The clicked-advertisement information may be information indicating the time, place and type of the advertisement clicked by the user.

After collecting and storing the user profile information and the advertisement consumption information in this way, the device 100 transmits the user profile information and the advertisement consumption information in step 518. The device 100 may transmit the user profile information to the user profile server 220, and the advertisement consumption information to the redirect server 230. Preferably, when transmitting the user profile information and the advertisement consumption information, the device 100 may also transmit information about the time the transmission of the user profile information and advertisement consumption information are requested, and DUID information of the user profile information and advertisement consumption information.

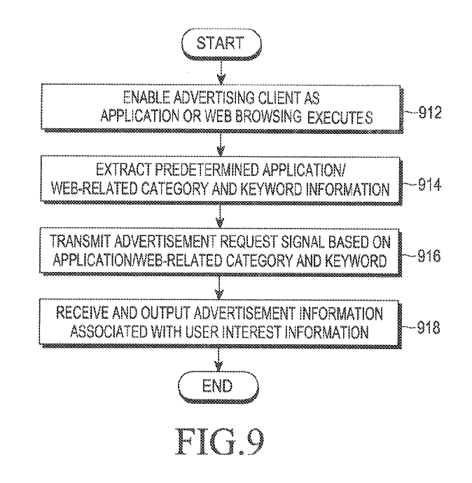

FIG. 9 is a flowchart illustrating an operation of receiving and outputting advertisements by a device 100 according to an embodiment of the present invention.

Referring to FIG. 9, as an app or web browsing executes, in which an advertising client produced using the advertising SDK is included, the device 100 enables the advertising client in Step 912. In Step 914, the device 100 extracts predetermined app and web-related category and keyword(s). In Step 916, the device 100 transmits an advertisement request signal to the advertising server 310 based on the extracted app and web-related category and keyword. In Step 918, upon receiving advertisement information associated with user interest information from the advertising server 310, the device 100 outputs the received advertisement information associated with user interest information. For example, the device 100 outputs audio signals corresponding to the advertisement information using the audio unit 150, or displays an advertisement screen on the display 160.

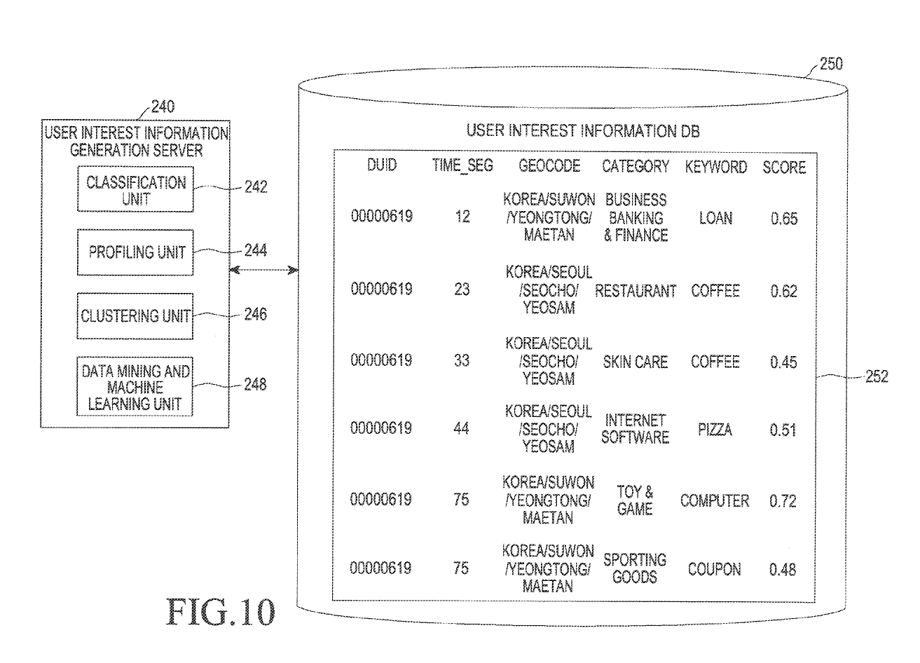

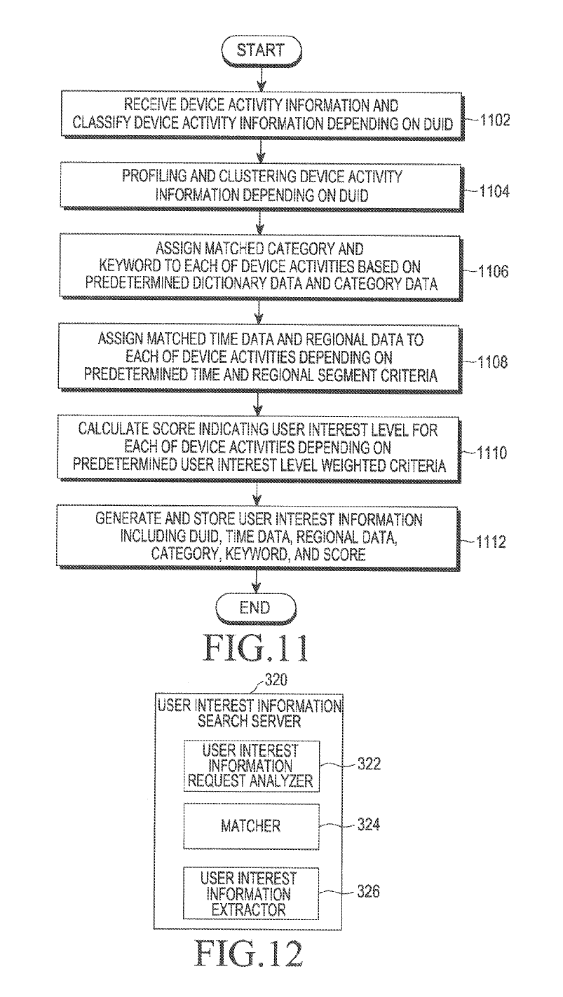

A structure and operation of a user interest information generation server 240 according to an embodiment of the present invention is described in more detail below. FIG. 10 is a diagram illustrating a structure of a user interest information generation server 240 according to an embodiment of the present invention, and FIG. 11 is a flowchart illustrating an operation of a user interest information generation server 240 according to an embodiment of the present invention.

Referring to FIG. 10, the user interest information generation server 240 includes a classification unit 242, a profiling unit 244, a clustering unit 246, and a data mining and machine learning unit 248.

Referring to FIG. 11, in Step 1102, the classification unit 242 receives device activity information including user profile information and advertisement consumption information, and classifies the received device activity information depending on the DUID.

In Step 1104, the profiling unit 244 and the clustering unit 246 perform profiling (information collection) and clustering (information grouping) on the device activity information according to the DUID, respectively.

In Step 1106, the data mining and machine learning unit 248 assigns matched category and keyword(s) to each of device activities included in the device activity information based on predetermined dictionary data and category data.

In Step 1108, the data mining and machine learning unit 248 assigns matched time data and regional data to each of device activities included in the device activity information based on predetermined time and regional segment criteria.

In Step 1110, the data mining and machine learning unit 248 calculates a score indicating a user interest level for each of device activities depending on predetermined user interest level weighted criteria. The predetermined user interest level weighted criteria is determined depending on whether the device activity is the recent device activity, and whether a frequency of the device activity is high.

If time data, regional data, category, keyword, and score are determined for each of device activities included in the device activity information, the data mining and machine learning unit 248 generates user interest information including a DUID, time data, regional data, category, keyword and score, and stores the generated user interest information in the user interest information DB 250, in Step 1112.

The user interest information is stored in the user interest information DB 250 as illustrated by user interest information object 252 in FIG. 10. User interest information object 252 illustrates an example where user interest information for a user of a device with a DUID of “00000619” is stored in the user interest information DB 250. “TIME_SEG” represents time data that is assigned depending on predetermined time segment criteria. For example, the time segment criteria include a time zone, which is divided according to day and time. For example, a time zone of “13:30˜17:30 PM, Sunday” may be represented as time data “14.” “GEOCODE” represents regional data (or geographic data) that is assigned according to predetermined regional segment criteria. For example, the regional segment criteria may be a geographical address defined in unit administrative district. For example, a location based on Global Positioning System (GPS) information or IP address may be represented as Street-based regional data such as “Korea/Suwon city/Yeongtong-Ku/Maetan-Dong.” In addition, “CATEGORY” and “KEYWORD” represent a category and a keyword(s), respectively, which are assigned based on predetermined dictionary data and category data. For example, if a device activity included in the device activity information includes a keyword related to the loan, CATEGORY and KEYWORD for the device activity may be represented as “business Banking & Finance” and “Loan,” respectively. In addition, “SCORE” represents a user interest level for each of device activities, which is calculated according to predetermined user interest level weighted criteria. For example, the score may be determined to have a higher value, as the device activity is a more recent device activity and the frequency of the device activity is higher.

A structure and operation of the user interest information search server 320 for searching for and providing user interest information stored in the user interest information DB 250 is described in more detail below.

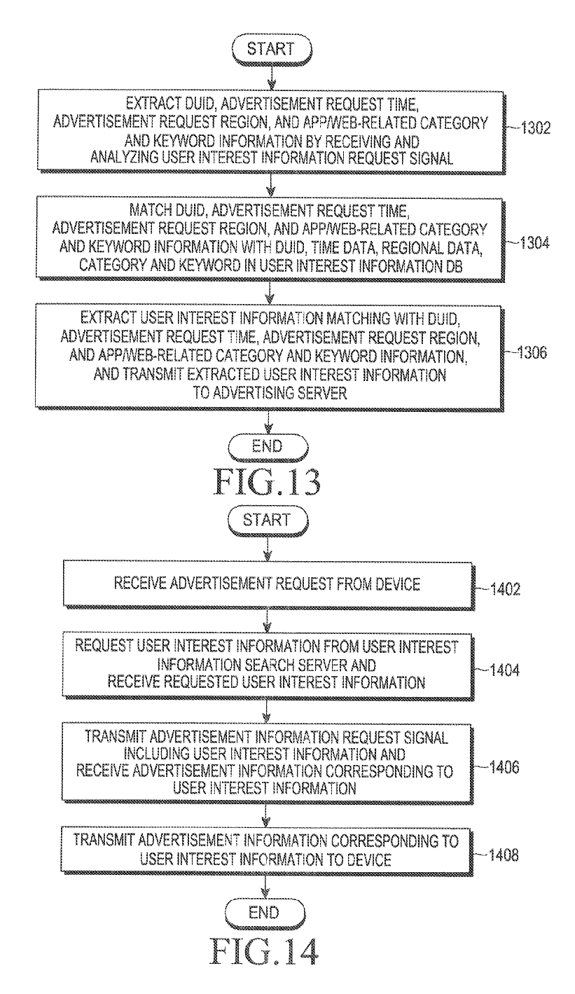

FIG. 12 is a diagram illustrating a structure of a user interest information search server 320 according to an embodiment of the present invention, and FIG. 13 is a flowchart illustrating an operation of a user interest information search server 320 according to an embodiment of the present invention.

Referring first to FIG. 12, the user interest information search server 320 includes a user interest information request analyzer 322, a matcher 324, and a user interest information extractor 326.

Referring to FIG. 13, in Step 1302, the user interest information request analyzer 322 analyzes a user interest information request signal received from the advertising server 310, and extracts the DUID, advertisement request time, advertisement request region, and app and web-related category and keyword information from the analyzed user interest information request signal.

In Step 1304, the matcher 324 matches the DUID, advertisement request time, advertisement request region, and app and web-related category and keyword information, with the DUID, time data, regional data, category and keyword in the user interest information DB 250, and provides the matching results to the user interest information extractor 326.

In Step 1306, the user interest information extractor 326 extracts user interest information matching with the DUID, advertisement request time, advertisement request region, and app and web-related category and keyword information, and transmits a user interest information response signal including the extracted user interest information to the advertising server 310.

An operation of the advertising server 310 for receiving the user interest information and providing advertisement corresponding to the user interest information is described in more detail below. FIG. 14 is a flowchart illustrating an operation of an advertising server 310 according to an embodiment of the present invention.

Referring to FIG. 14, upon receiving an advertisement request signal from the device 100 in Step 1402, the advertising server 310 requests user interest information from the user interest information search server 320, and receives the requested user interest information therefrom in Step 1404. The advertisement request signal from the device 100 includes DUID, advertisement request location, and app and web-related category and keyword information. The advertising server 310 transmits a user interest information request signal including a DUID, advertisement request location, advertisement request time, and app and web-related category and keyword information based on the information included in the advertisement request signal.

Upon receiving the user interest information from the user interest information search server 320, the advertising server 310 transmits an advertisement information request signal including the user interest information to the advertisement matching server 340, and receives advertisement information corresponding to the user interest information from the advertisement matching server 340, in Step 1406. The advertisement information request signal including the user interest information includes category and keyword information corresponding to the user interest information along with the DUID, advertisement request location, advertisement request time, and app and web-related category and keyword information.

In Step 1408, upon receiving the advertisement information corresponding to the user interest information, the advertising server 310 provides the received advertisement information to the device 100.

As the advertisement information corresponding to the user interest information from the advertising server 310 is provided to the device 100, the device 100 receives advertisement with a high user interest level and outputs the received advertisement.

The above-described user interest information-based advertisement providing method may be implemented in a program and stored in storage media, and the device 100 provides user interest information-based advertisements to its user by downloading and installing a program (e.g., app) for providing advertisements based on user interest information, and then executing the program, as described herein.

The embodiments of the present invention can be implemented in the form of hardware, software, or a combination thereof. For example, the software may be stored, in volatile or non-volatile storage devices such as a Read Only Memory (ROM), a Random Access Memory (RAM) and the like, a memory chip and Integrated Circuit (IC), or for example, in a storage medium which is optically or magnetically recordable and is readable by machine (e.g., computer), such as Compact Disk (CD), Digital Versatile Disk (DVD), magnetic disk, and magnetic tape. Accordingly, the present invention includes a program including codes for implementing the system and/or method described herein, and a storage medium, which stores this program and is readable by machine (e.g., computer). Further, the program can be electronically transferred through a medium such as communication signals, which are transmitted through a wired or wireless connection.

Although the device activity information described above includes user profile information and/or advertisement consumption information as one example, the device activity information may also include all device operation-related information. In addition, although user profile information and/or advertisement consumption information are collected by an advertising client during app execution or web browsing, the user profile information and/or advertisement consumption information may also be collected in other ways. Furthermore, although the components for generating user interest information and the components for providing advertisements based on the user interest information are described as separate components, these components may also be configured within a single device.

As is apparent from the foregoing description, according to embodiments of the present invention, advertisements with a high user interest level among the numerous advertisements may be provided using the user interest information corresponding to the individual's interest span of mobile device users, making it possible to maximize the advertising effectiveness.

In addition, advertisements may be provided using the user interest information which is generated depending on the device activity information that includes various user profile information, such as app execution information, web browsing information, multimedia content (music or video) playback information and search information, and user's advertisement consumption information, such as advertisement selection or click information, thereby making it possible to provide customized advertisements to the individual users.

While the present invention has been described with reference to certain embodiments thereof, it will be understood by those skilled in the art that various modifications in form and detail can be made therein without departing from the spirit and scope of the present invention as defined by the appended claims and their equivalents.

What is claimed is:

1. A system for providing advertisement based on user interest information, comprising:
a user interest information search server for searching for user interest information associated with an advertisement request from a device, from among user interest information generated based on device activity information associated with user's device operations; and
an advertising server for providing advertisement information corresponding to the searched user interest information from among stored advertisement information, to the device.

2. The system of claim 1, further comprising a user interest information generation server for generating user interest information based on the device activity information.

3. The system of claim 2, wherein the device activity information includes user profile information including app execution information, web browsing information, multimedia content playback information, and search information.

4. The system of claim 2, wherein the device activity information includes advertisement consumption information including advertisement receipt and click information.

5. The system of claim 3, further comprising:
a user profile server for collecting the user profile information from the device; and
a first device activity information DataBase (DB) for storing the user profile information.

6. The system of claim 4, further comprising:
a redirect server for collecting the advertisement consumption information from the device; and
a second device activity information DB for storing the advertisement consumption information.

7. The system of claim 1, further comprising:
an advertisement information DB for storing advertisement information; and
an advertisement matching server for matching the stored advertisement information with the user interest information, extracting advertisement information corresponding to the user interest information, and providing the extracted advertisement information to the advertising server.

8. The system of claim 2, wherein the user interest information generation server comprises:
a classification unit for receiving and classifying device activity information associated with the user's device operations;
a profiling unit for profiling the device activity information;
a clustering unit for clustering the device activity information; and
a data mining and machine learning unit for assigning a matched category, a keyword, time data and regional data to each of the device activities included in the device activity information according to predetermined criteria, calculating a score indicating a user interest level for each of the device activities depending on predetermined user interest level weighted criteria, and generating user interest information including a Device Unique IDentification (DUID), time data, regional data, a category, a keyword, and a score.

9. A method for providing advertisement based on user interest information, comprising:
receiving, from a device, user interest information generated based on device activity information associated with user's device operations; and
providing advertisement information corresponding to the user interest information from among stored advertisement information, to the device.

10. The method of claim 9, further comprising generating the user interest information.

11. The method of claim 10, wherein the device activity information includes user profile information including app execution information, web browsing information, multimedia content playback information, and search information.

12. The method of claim 10, wherein the device activity information includes advertisement consumption information including advertisement receipt and click information.

13. The method of claim 11, further comprising:
collecting the user profile information from the device; and
storing the user profile information.

14. The method of claim 12, further comprising:
collecting the advertisement consumption information from the device; and
storing the advertisement consumption information.

15. The method of claim 9, further comprising:
storing advertisement information by an advertisement information DataBase (DB); and
matching, by an advertisement matching server, the stored advertisement information with the user interest information, extracting advertisement information corresponding to the user interest information, and providing the extracted advertisement information to an advertising server.

16. The method of claim 10, wherein generating the user interest information comprises:
receiving and classifying device activity information associated with the user's device operations;
profiling and clustering the classified device activity information;
assigning a matched category, a keyword, time data and regional data to each of device activities included in the device activity information depending on predetermined criteria;
calculating a score indicating a user interest level for each of the device activities depending on predetermined user interest level weighted criteria; and
generating user interest information including a Device Unique IDentification (DUID), time data, regional data, a category, a keyword, and a score.

17. A device comprising:
a storage for storing device activity information that includes user profile information associated with a user device operations and advertisement consumption information by the user;
a communication unit for transmitting the device activity information to an advertisement providing apparatus; and
a controller for collecting and storing the device activity information, and transmitting the collected device activity information.

18. The device of claim 17, wherein the controller collects the device activity information, if collection of device activity information is authorized.

19. The device of claim 17, wherein the communication unit transmits the collected device activity information once or a predetermined number of times a day, or upon collection of the device activity information.

20. The device of claim 17, wherein the user profile information includes at least one of app execution information, web browsing information, multimedia content playback information, and search information in the device.

21. The device of claim 17, wherein the advertisement consumption information includes at least one of advertisement receipt information and advertisement click information in the device.

22. The device of claim 17, further comprising:
a display for displaying advertisement information, corresponding to the user interest information, under control of the controller; and
an audio unit for outputting an audio signal corresponding to the advertisement information, under control of the controller,
wherein the storage stores an application or a web browsing program, the communication unit transmits an advertisement request signal according to execution of the application or web browsing program, and receives the advertisement information corresponding to the user interest information that is based on the device activity information, and the controller outputs the received advertisement information upon receiving the advertisement information.

23. The device of claim 22, wherein the web application includes an advertising client produced using an advertising Software Development Kit (SDK).

24. A method for providing advertisement in a device, the method comprising:
storing device activity information that includes user profile information associated with a user device operations and advertisement consumption information by the user; and
transmitting the device activity information to an advertisement providing apparatus.

25. The method of claim 24, further comprising:
transmitting an advertisement request signal to the advertisement providing apparatus based on a predetermined application or web-related category and keyword information as an application or web browsing is executed; and
receiving advertisement information corresponding to the user interest information associated with the device activity information from the advertisement providing apparatus in response to the advertisement request signal, and outputting the received advertisement information.

26. The method of claim 24, further comprising transmitting the collected device activity information once or a predetermined number of times a day, or upon collection of the device activity information.

27. The method of claim 24, wherein the user profile information includes at least one of app execution information, web browsing information, multimedia content playback information, and search information in the device.

28. The method of claim 24, wherein the advertisement consumption information includes at least one of advertisement receipt information and advertisement click information in the device.

29. A storage media for storing thereon a program performed in a device for executing a method for providing advertisement based on user interest information, the method comprising:
transmitting an advertisement request signal based on predetermined application and web-related category and keyword information as a web application executes;
receiving advertisement information corresponding to user interest information in response to the advertisement request signal; and
outputting the received advertisement.
